(19) United States
(12) Patent Application Publication
(10) Pub. No.: US 2013/0157011 A1
(43) Pub. Date: Jun. 20, 2013

(54) RESIN SUBSTRATE AND METHOD OF MANUFACTURING THE SAME

(71) Applicant: SAMSUNG ELECTRO-MECHANICS CO., LTD., Suwon (KR)

(72) Inventors: Sung Nam Cho, Suwon (KR); Jun Young Kim, Suwon (KR); Tae Hoon Kim, Suwon (KR); Young Kwan Seo, Suwon (KR)

(73) Assignee: SAMSUNG ELECTRO-MECHANICS CO., LTD., Suwon (KR)

(21) Appl. No.: 13/718,939

(22) Filed: Dec. 18, 2012

(30) Foreign Application Priority Data
Dec. 19, 2011 (KR) 10-2012-0137353

(51) Int. Cl. H01B 3/00; H01B 19/04

(52) U.S. Cl. CPC H01B 3/008; H01B 19/04
USPC 428/147; 216/83; 428/141; 428/143

(57) ABSTRACT

Disclosed herein is a resin substrate, including: an insulating material; and a resin layer formed on the insulating material and having surface roughness.

### CROSS REFERENCE TO RELATED APPLICATION

This application claims the benefit of Korean Patent Application No. 10-2011-0137353, filed Dec. 19, 2011, entitled “Resin base and method for manufacturing the same”, which is hereby incorporated by reference in its entirety into this application.

### BACKGROUND OF THE INVENTION

1. Technical Field

The present invention relates to a resin substrate and a method of manufacturing the same.

2. Description of the Related Art

Recently, with the improvement in the performance of equipment, a high-performance and high-reliability thin substrate has been required. Further, in the case of a buildup film, in order to solve the problems occurring in a reliability test, an insulting resin having a low thermal expansion coefficient has been required.

Generally, the thermal expansion coefficient of a resin changes depending on the amount of inorganic filler included in the resin. According to research results, when the amount of inorganic filler in the resin increases by 10 wt %, the thermal expansion coefficient of the resin decreases by about 10 ppm, and thus the amount of inorganic filler in the resin must be 50 wt % or more in order to manufacture a resin substrate having a thermal expansion coefficient of 20˜30 ppm or less.

That is, in order to manufacture a resin substrate having a low thermal expansion coefficient, the amount of inorganic filler in the resin substrate must be increased.

Meanwhile, in order to form high-density wiring, prior to a copper plating process, the surface of a resin layer is partially etched by a desmear process to impart it with roughness. In this case, as described above, when the amount of inorganic filler in the resin layer is high, the amount of resin in the resin layer relatively becomes low, so that there is a problem in that a large amount of inorganic filler having low adhesivity is exposed onto the surface of the resin layer while the resin layer is etched by the desmear process.

Like this, when the inorganic filler is exposed onto the surface of the resin layer, the adhesion between the resin layer and a plated layer formed by a copper plating process for forming wiring becomes low, so that there is a problem in that the plated layer is easily separated from the resin layer.

### SUMMARY OF THE INVENTION

Accordingly, the present invention has been devised to solve the above-mentioned problems, and the present invention provides a resin substrate which has a low thermal expansion coefficient and a surface on which there is no inorganic filler, and a method of manufacturing the same.

Further, the present invention provides a resin substrate on which surface roughness can be effectively created, and a method of manufacturing the same.

An aspect of the present invention provides a resin substrate, including: an insulating material; and a resin layer formed on the insulating material and having surface roughness.

Here, the resin layer may be formed in a shape of droplets overlapping each other, and each of the droplets may have a plurality of recesses.

Further, the resin layer may include particles.

In this case, the particles may be organic particles or inorganic particles, or may be rubber particles.

Further, each of the particles may have a diameter of 10˜200 nm.

Further, the insulating material may include 50˜90 wt % of inorganic filler based on the total weight thereof.

A further aspect of the present invention provides a method of manufacturing a resin substrate, including: providing an insulating material; forming a resin layer containing particles on the insulating material by an ink-jet process; and removing the particles from the resin layer by a desmear process to impart the surface of the resin layer with roughness.

Here, in the forming of the resin layer, the resin layer may be formed by applying ink containing the particles onto the insulating material using an ink-jet head.

In this case, a drive frequency for applying the ink may be 5˜50 kHz.

Further, the resin layer may be formed in a shape of droplets overlapping each other.

Further, each of the droplets may have a volume of 10˜50 μl.

Further, 5˜45% of the droplets may overlap each other.

Further, the resin layer may have a thickness of 10˜20 μm.

Further, the forming of the resin layer may be conducted at a temperature of 35° C.˜70° C.

Further, the particles may be organic particles or inorganic particles, or may be rubber particles.

Further, each of the particles may have a diameter of 10˜200 nm.

Further, the insulating material may include 50˜90 wt % of inorganic filler based on the total weight thereof.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a resin substrate according to an embodiment of the present invention; and

FIGS. 2 to 4 are sectional views sequentially showing a method of manufacturing a resin substrate according to an embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Resin Substrate

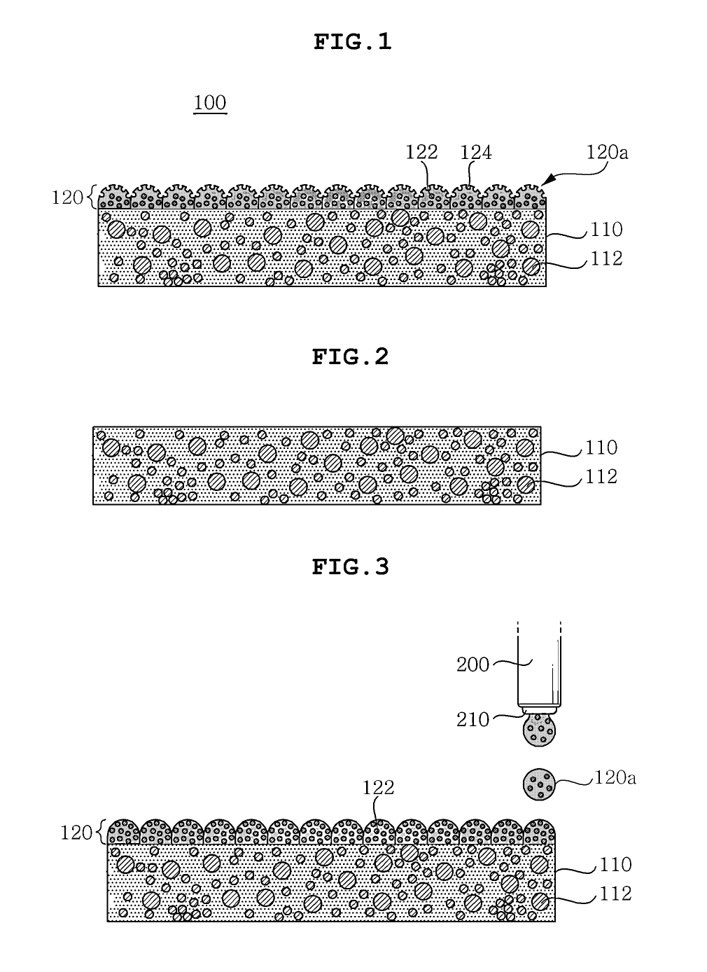

FIG. 1 is a sectional view showing a resin substrate according to an embodiment of the present invention.

Referring to FIG. 1, the resin substrate 100 according to an embodiment of the present invention includes: an insulating material 110; and a resin layer 120 formed on the insulating material 110 and having surface roughness.

As shown in FIG. 1, the insulating material layer 110 may be made of a resin containing inorganic filler 112.

In this case, the amount of the inorganic filer 112 in the insulating material 110 may be 50 wt %˜90 wt %, but is not particularly limited thereto.

Generally, when the amount of inorganic filler is 50 wt % or less, an insulting material layer having desired roughness and peeling strength can be obtained by optimizing the composition of the resin, but an insulating material layer having a thermal expansion coefficient of 30 ppm or less cannot be obtained.

Currently, in the related field, an insulating material layer having a low thermal expansion coefficient is required. Therefore, in this embodiment, in order to form an insulating material 110 having a thermal expansion coefficient of 20 ppm˜30 ppm, the amount of the inorganic filler 112 may be 50 wt %˜90 wt %.

In this case, when the amount of the organic filler 112 is greater than 90 wt %, the organic filler 112 becomes exposed onto the surface of the insulating material 110, or the fluidity of the inorganic filler 112 in a resin becomes poor because the amount of the resin in the insulating material 110 is very small.

In this embodiment, the inorganic filler 112 may be silica, but is not limited thereto. Organic filler as well as inorganic filler may also be used in the present invention.

Further, in order to improve the dispersity of the inorganic filler 112 in the insulating material 110, the inorganic filler 112 may be surface-treated with a silane coupling agent or the resin may be mixed with a silane coupling agent.

Here, examples of the silane coupling agent may include, but are not limited to, an epoxy silane-based coupling agent, a trimethoxy silane-based coupling agent, a mercaptosilane-based coupling agent, and the like. They may be used independently or in a mixture thereof.

Further, in order to improve the dispersity of the inorganic filler 112 in the insulating material 110, the resin may be mixed with a dispersant.

Here, examples of the dispersant may include, but are not limited to, an alkyl ether-based dispersant, a sorbitane ester-based dispersant, an alkyl polyether amine-based dispersant, a polymer-based dispersant, and the like. They may be used independently or in a mixture thereof.

In this embodiment, the resin layer 120 may be formed in the shape of droplets overlapping each other, but the present invention is not limited thereto.

That is, as shown in FIG. 1, since droplets 120a are piled one above another, steps occur between the droplets 120, and thus the resin layer 120 has an uneven surface.

Further, in this embodiment, the resin layer 120 may include particles 122 therein. When the particles 122 are removed from the surface of the resin layer 120, recesses 124 corresponding to the particles 122 can be formed.

Here, the particles 122 may be inorganic particles or organic particles. In this embodiment, rubber particles are used as the particles 122, but the particles 122 are not limited thereto.

Further, in this embodiment, particles having a diameter of 10 nm˜200 nm may be used as the particles 122, but the particles 122 are not limited thereto.

In this case, when the diameter of the particles 122 is less than 10 nm, the particles 122 are excessively small, and thus it is not easy for the recesses 124 formed by removing the particles 122 from the surface of the resin layer 120 to impart the surface of the resin layer 120 with roughness. In contrast, when the diameter of the particles 122 is more than 200 nm, the particles 122 are excessively large, and thus the recesses 124 formed by removing the particles 122 from the surface of the resin layer 120 are also excessively large, so that the surface of the resin layer excessively becomes rough, and thus it is difficult to form microwirings.

FIG. 1 shows the roughness of the resin layer 120 of this embodiment. As described above, this roughness can be primarily imparted by overlapping the droplets 120a, and can be secondarily imparted by removing the particles 122 included in the resin layer 120 and located at the surface thereof to form the recesses 124 corresponding to the particles 124.

Like this, since the roughness is imparted over two times, a more three-dimensional roughness can be imparted, thus improving the adhesion between the insulating material 110 and the plated layer to be formed in subsequent processes.

Method of Manufacturing Resin Substrate

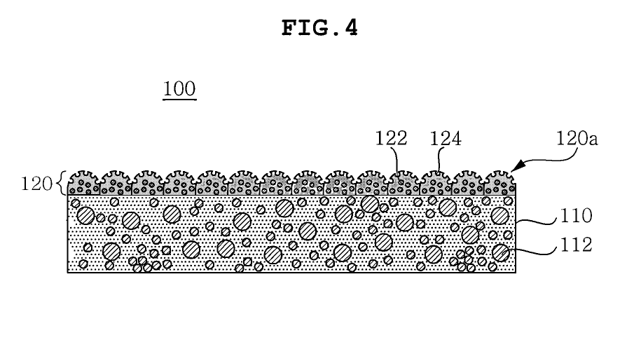

FIGS. 2 to 4 are sectional views sequentially showing a method of manufacturing a resin substrate according to an embodiment of the present invention.

First, referring to FIG. 2, an insulating material layer 110 is provided.

In this embodiment, the insulating material 110 may be formed by mixing a resin with inorganic filler 112.

In this case, the amount of the inorganic filler 112 in the insulating material 110 may be 50 wt %˜90 wt %, but is not particularly limited thereto.

Here, since the reason for limiting the amount of the inorganic filler 112 to this range was already explained in the description of the resin substrate 100, the description thereof will be omitted.

Further, in this embodiment, the inorganic filler 112 may be silica, but is not limited thereto. Organic filler as well as inorganic filler may also be used in the present invention.

Further, in order to improve the dispersity of the inorganic filler 112 in the insulating material 110, the inorganic filler 112 may be surface-treated with a silane coupling agent, the resin may be mixed with a silane coupling agent, or the resin may be mixed with a dispersant.

Since the process of forming the insulating material 110 containing the inorganic filler 112 is a technology generally known in the related field, the detailed description thereof will be omitted.

Further, since the materials which can be used as the silane coupling agent or the dispersant were described above, the description thereof will be omitted.

Subsequently, referring to FIG. 3, a resin layer 120 containing particles 122 is formed on the insulating material 110.

In this embodiment, the process used to form the resin layer 120 may be, but is not limited to, an ink-jet printing process.

For example, as shown in FIG. 3, the resin layer 120 is formed by applying ink containing particles 122 onto the insulating material 110 using an ink-jet head 200. In this case, the ink is applied onto the insulating material layer 110 in the form of droplet 120a by a nozzle 210 of the ink-jet head 200, and, finally, the resin layer 120 may be formed in the shape of droplets 120a overlapping each other, as shown in FIG. 3.

This process is only an embodiment of the present invention, and the present invention is not limited to this process.

In this embodiment, the volume of the droplet 120a discharged from the nozzle 210 of the ink-jet head 200 may be 10 pl˜50 pl.

When the volume of the droplet 120a is less than 10 pl, since the droplet 120a is discharged from the nozzle 210 of the ink-jet head 200 and then scattered, the linearity thereof becomes low. Further, when the volume thereof is more than 50 pl, since the size of the droplet 120a printed on the insulating material layer 110 becomes excessively large, it is difficult to impart effective roughness. Therefore, it is preferred that the volume thereof be 10 pl˜50 pl.

Further, in this embodiment, 5%˜45% of the droplets 120a may overlap each other on the insulating material layer 110.

When less than 5% of the droplets 120a overlap each other, it is difficult to provide effective curvature. Further, when more than 45% of the droplets 120a overlap each other, it is also difficult to impart effective roughness. Therefore, it is preferred that the rate thereof be 5%˜45%.

Further, in this embodiment, the thickness of the resin layer 120 may be 10 μm˜20 μm.

When the thickness of the resin layer 120 is less than 10 μm, since the resin layer 120 is excessively thin, the surface of the insulating material 110 as well as the resin layer 120 is etched during a desmear process, and thus the inorganic filler 112 becomes exposed onto the surface of the insulating material 110. Further, when the thickness thereof is more than 20 μm, since it is suitable that the total thickness of the finally-manufactured resin substrate 100 be about 30 μm, the physical properties of the resin substrate 100 are influenced thereby. Therefore, it is preferred that the thickness thereof be 10 μm˜20 μm.

Further, in this embodiment, the process of forming the resin layer 120 may be conducted at a temperature of 35° C.˜70° C.

When the process of forming the resin layer 120 is conducted at a temperature lower than 35° C., it takes a lot of time to obtain the desired curvature, thus increasing process time. Further, when the process of forming the resin layer 120 is conducted at a temperature higher than 70° C., the is nozzle 210 of the ink-jet head 200 is plugged, and thus the ink cannot be normally discharged through the nozzle 210.

Here, the particles 122 may be inorganic particles or organic particles. In this embodiment, rubber particles are used as the particles 122, but the particles 122 are not limited thereto.

Further, in this embodiment, particles having a diameter of 10 nm˜200 nm may be used as the particles 122, but the particles 122 are not limited thereto.

In this case, when the diameter of the particles 122 is less than 10 nm, the particles 122 are excessively small, and thus the recesses 124 formed by removing the particles 122 from the surface of the resin layer 120 cannot easily impart the surface of the resin layer 120 with roughness. In contrast, when the diameter of the particles 122 is more than 200 nm, the particles 122 are excessively large, and thus the recesses 124 formed by removing the particles 122 from the surface of the resin layer 120 are also excessively large, so that the surface of the resin layer excessively becomes rough, and thus it is difficult to form microwirings.

Subsequently, referring to FIG. 4, the particles 122 are removed from the resin layer 120 by a desmear process to impart the surface of the resin layer 120 with roughness.

In this embodiment, the desmear process may be conducted using a desmear solution. In this case, the desmear solution may be a permanganate solution, but is not limited thereto.

Generally, the desmear process is conducted in order to remove burrs and the like before a plating process is conducted after via holes for connecting circuit layers are formed by processing. In the present invention, the desmear process can be used to impart the surface of the resin substrate 100 with roughness by etching as well as to remove burrs and the like.

Therefore, the adhesion between the resin substrate 100 and the plated layer formed by a subsequent plating process can be improved.

Meanwhile, since the resin included in the resin substrate 100 reacts with the desmear solution to be etched prior to the inorganic filler 112 included in the resin substrate 100 during the desmear process, the resin substrate 100 including a large amount of the inorganic filler 112 is problematic in that the inorganic filler 112 becomes exposed onto the surface of the insulating material 110 because the resin is rapidly removed.

Therefore, in this embodiment, the particles 122 included in the resin layer 120 are characterized in that they react with the desmear solution prior to the resin. For example, as described above, rubber particles were used as the particles 122.

Accordingly, the particles 122 of the resin layer 120 are previously removed by the desmear solution, and thus, as shown in FIG. 4, recesses 124 corresponding to the removed particles 122 can be formed in a state in which the resin partially remains on the surface of the resin layer 120.

Therefore, according to the present invention, a resin layer, which contains particles in order to impart roughness, is formed on an insulating material layer containing a large amount of inorganic filler, and then the particles are removed from the resin layer by a desmear process, thereby manufacturing a resin substrate having a low thermal expansion coefficient and effective roughness.

As described above, according to the present invention, since a resin layer for imparting roughness is formed on an insulating material layer and then a desmear process is performed, it is possible to impart the surface of a resin substrate with roughness without exposing inorganic filler to the surface thereof even when the resin substrate includes 50 wt % or more of inorganic filler.

Further, according to the present invention, since inorganic filler does not become exposed onto the surface of the resin substrate, the adhesion between the resin substrate and the plated layer can be improved.

Further, according to the present invention, since the resin substrate can include inorganic filler in an amount of 50 wt % or more, it is possible to easily manufacture a resin substrate having a low thermal expansion coefficient of 20˜30 ppm.

Furthermore, according to the present invention, since a resin substrate having a low thermal expansion coefficient can be easily manufactured, it is possible to prevent a substrate from warping during a subsequent process of manufacturing a substrate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A resin substrate, comprising:
an insulating material layer; and
a resin layer formed on the insulating material and having surface roughness.

2. The resin substrate according to claim 1, wherein the resin layer is formed in a shape of droplets overlapping each other.

3. The resin substrate according to claim 2, wherein each of the droplets has a plurality of recesses.

4. The resin substrate according to claim 1, wherein the resin layer includes particles.

5. The resin substrate according to claim 4, wherein the particles are organic particles or inorganic particles.

6. The resin substrate according to claim 4, wherein the particles are rubber particles.

7. The resin substrate according to claim 4, wherein each of the particles has a diameter of 10˜200 nm.

8. The resin substrate according to claim 1, wherein the insulating material includes 50˜90 wt % of inorganic filler based on a total weight thereof.

9. A method of manufacturing a resin substrate, comprising:
providing an insulating material;
forming a resin layer containing particles on the insulating material by an ink-jet process; and
removing the particles from the resin layer by a desmear process to impart a surface of the resin layer with roughness.

10. The method according to claim 9, wherein, in the forming of the resin layer, the resin layer is formed by applying ink containing the particles onto the insulating material using an ink-jet head.

11. The method according to claim 10, wherein a drive frequency for applying the ink is 5˜50 kHz.

12. The method according to claim 10, wherein the resin layer is formed in a shape of droplets overlapping each other.

13. The method according to claim 12, wherein each of the droplets has a volume of 10˜50 pl.

14. The method according to claim 12, wherein 5˜45% of the droplets overlap each other.

15. The method according to claim 9, wherein the resin layer has a thickness of 10˜20 μm.

16. The method according to claim 9, wherein the forming of the resin layer is conducted at a temperature of 35° C.˜70° C.

17. The method according to claim 9, wherein the particles are organic particles or inorganic particles.

18. The method according to claim 9, wherein the particles are rubber particles.

19. The method according to claim 9, wherein each of the particles has a diameter of 10˜200 nm.

20. The method according to claim 9, wherein the insulating material includes 50˜90 wt % of inorganic filler based on a total weight thereof.
